(19) United States
(12) Patent Application Publication
(10) Pub. No.: US 2023/0315999 A1
(43) Pub. Date: Oct. 5, 2023

(54) SYSTEMS AND METHODS FOR INTENT DISCOVERY

(71) Applicant: ADA Support Inc., Toronto (CA)

(72) Inventors: Salman Mohammed, Toronto (CA); Gordon Gibson, Toronto (CA); Liam Bolton, Ancaster (CA); Adam Sils, Kelowna (CA); Viacheslav Tradunskyi, Toronto (CA); Michael Pham, Austin, TX (US); Raheleh Makki Niri, Richmond Hill (CA)

(21) Appl. No.: 17/710,821

(22) Filed: Mar. 31, 2022

(51) Int. Cl. G06F 40/35; G06F 40/40; G06F 16/332; G06N 20/20

(52) U.S. Cl. CPC G06F 40/35; G06F 40/40; G06F 16/3325; G06N 20/20

(57) ABSTRACT

Systems and method are disclosed for processing unrecognized user queries. A received user query is classified via a first machine learning model. A first classification determination is made for the user query. In response to the first classification determination, features of the user query are identified via a second machine learning model. The user query is grouped into a cluster based on the features of the user query. Information about the cluster is displayed for prompting a user action. The user action may include identification of an intent for the user query.

### CROSS-REFERENCE TO RELATED APPLICATION(S)

The present application is related to U.S. application Ser. No. 17/361,114, filed on Jun. 28, 2021, entitled “Method and System for Generating an Intent Classifier,” the content of which is incorporated herein by reference.

### FIELD

One or more aspects of embodiments according to the present disclosure relate to natural language processing, and more particularly to processing unrecognized inputs for intent discovery.

### BACKGROUND

A business may employ automated systems and representatives of the business to process transactions and/or service the needs of its customers. Utilizing human agents to interact with the customers may sometime result in delays if the agents are not available to service the customers. Utilizing human agents may also be costly for the business due to increased overhead and increased complexity to the business operation.

One mechanism for handling customer needs in a more efficient manner may be to employ chatbots. Using chatbots, however, may be challenging. For example, if a chatbot has not been trained to recognize a particular user question, the chatbot may not be effective in responding to the question, and may be unable to handle the customer needs.

The above information disclosed in this Background section is only for enhancement of understanding of the background of the present disclosure, and therefore, it may contain information that does not form prior art.

### SUMMARY

Embodiments of the present disclosure are directed to a method that includes receiving a user query; classifying the user query via a first machine learning model; making a first classification determination for the user query; in response to the first classification determination, identifying features of the user query via a second machine learning model; grouping the user query into a cluster based on the features of the user query; and causing display of information about the cluster for prompting a user action.

In one embodiment, the classifying of the user query includes predicting an intent of the user query.

In one embodiment, the first classification determination includes a determination that prediction of the intent is below a threshold level of confidence.

In one embodiment, the second machine learning model includes a plurality of embedding layers, wherein the features of the user query include embeddings generated by one or more of the plurality of embedding layers.

In one embodiment, the second machine learning model includes a pre-trained language model, and the method further includes adjusting a parameter of the pre-trained language model for a particular task.

In one embodiment, the method further includes identifying a keyword from a plurality of first queries in the cluster, wherein the information about the cluster includes the keyword.

In one embodiment, the identifying of the keyword includes: generating first unigrams of the first queries in the cluster; generating second unigrams of second queries in a second cluster; comparing the first unigrams against the second unigrams; and selecting the keyword based on the comparing.

In one embodiment, the method includes generating a summary of the cluster, wherein the summary includes one or more of the keywords.

In one embodiment, the method includes generating a summary of the cluster comprising, wherein the generating of the summary includes: invoking a summarization model based on one or more queries in the cluster; identifying a word output by the summarization model; and including the word into the summary.

In one embodiment, the user action includes identification of an intent for the user query.

In one embodiment, the method further includes: labeling the user query with the intent; and training the first machine learning model based on the user query and the intent.

Embodiments of the present disclosure are further directed to a system that includes a processor, and a memory. The memory includes instructions that, when executed by the processor, cause the processor to: receive a user query; classify the user query via a first machine learning model; make a first classification determination for the user query; in response to the first classification determination, identify features of the user query via a second machine learning model; group the user query into a cluster based on the features of the user query; and cause display of information about the cluster for prompting a user action.

As a person of skill in the art should recognize, embodiments of the present disclosure allow unrecognized queries to be automatically grouped and output for efficient review and assignment of intents. The labeled unrecognized queries may then be used to re-train the intent classifier, helping improve the prediction capabilities of the intent classifier.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a block diagram of a chatbot system according to one embodiment;

FIG. 2 illustrates a data flow diagram of an example intent classification method for an inference task, the method being performed by and implemented in an intent classification system, according to example embodiments;

FIG. 3 is a schematic diagram of hardware implementing the intent classification system, according to example embodiments;

FIG. 4 illustrates a block diagram of an example method implemented in the embedding generator module during training, according to example embodiments;

FIG. 5 is a data flow diagram illustrating the fine-tuning method performed in the multi-task deep neural network module, according to example embodiments;

FIG. 6 is an illustrative diagram of the method performed by the feature extraction module, according to example embodiments;

FIG. 7 is a flowchart of an example method for generating the MT-DNN-BERT language model from a pre-trained language model, according to example embodiments;

FIG. 8 is a flowchart of an example method for training a plurality of neural network models used in generating the MT-DNN-BERT language model described FIG. 7, according to example embodiments;

FIG. 9 is an example chatbot system implementing modules of the intent classification system of FIG. 2, according to example embodiments;

FIG. 10 is a conceptual block diagram of a training system according to one embodiment;

FIG. 11 is a flow diagram of a process for classifying intents according to one embodiment;

FIG. 12 is a flow diagram of a process for training a machine learning model of the intent classification system using a dataset of unrecognized queries according to one embodiment;

FIG. 13 is a conceptual diagram of incoming queries (chatter questions) for being classified into one of the known intents according to one embodiment;

FIG. 14A is a screenshot of a display with information of clusters generated based on example unrecognized queries according to one embodiment;

FIG. 14B is a screenshot of a display in response to selection of a “profile page returning” cluster according to one embodiment;

FIG. 15 is a block diagram of a network environment for employing and training chatbots according to one embodiment; and

FIG. 16 is a block diagram of a computing device according to one embodiment.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

A business may employ an automated answering system, a chat bot, a chat robot, a chatterbot, a dialog system, a conversational agent, and/or the like (collectively referred to as a chatbot) to interact with customers. Customers may use natural language to pose questions to the chatbot, and the chatbot may provide answers that are aimed to be responsive to the questions. The quality/responsiveness of the answers may depend on the training received by the chatbot. If the chatbot's training is insufficient to properly answer a user's question, it may lead to decreased customer satisfaction.

Training chatbots, however, can be an arduous task. When training is performed by a non-technical customer support team member (hereinafter referred to as a chatbot administrator), the training of a chatbot may be even more difficult. Accordingly, there is a need for systems and methods to aid the chatbot administrators to train chatbots. As a person of skill in the art should appreciate, efficient and effective training of chatbots result in more efficient and effective interactions with users of the chatbot.

In general terms, embodiments of the present disclosure are directed to systems and methods for intent discovery of user questions. The term “questions” is used herein to also refer to queries, requests, or other types of inputs from a user, and is not limited to just questions. Accordingly, the terms questions, queries, and inputs will be used interchangeably herein.

In one embodiment, an intent classification system receives one or more user questions and attempts to classify the questions into one or more user intents. The intents may be answers, or may be used to generate answers, that the chatbot may output to respond to the user's questions.

Any question that is not classified within a certain level of confidence may represent questions that were not previously anticipated by the chatbot administrators, and hence, not used during training of the classification system to associate with a user intent. The unrecognized/unclassified questions may be aggregated into a dataset, and used to retrain the intent classification system.

In one embodiment, the dataset of unclassified questions is provided to the intent classification system for processing. The intent classification system may be configured to convert the unclassified questions in the dataset, into semantic representations taking the form of context-aware sentence embeddings. In one embodiment, a clustering algorithm uses the semantic representations to group the unclassified questions into one or more clusters. The clustering algorithm may further identify relevant keywords in the cluster. For example, the identified keywords may be words that appear more frequently within a given cluster than the other clusters.

In one embodiment, a graphical user interface (GUI) organizes the unrecognized questions into their respective clusters. The clusters may be identified by a topic/cluster summary. The identified keywords for the clusters may then be displayed along with the topic via the GUI.

In one embodiment, an administrator interacts with the GUI to view the clusters of unrecognized questions in an organized and efficient manner. The chatbot administrator may then generate an intent or answer (collectively referred to as an intent) based on the output keywords, and/or cluster summary. In one embodiment, the intent may be automatically generated and output as a recommended intent for the chatbot administrator to accept, reject, or modify.

A generated intent may be assigned to one or more questions in the cluster. The one or more questions and assigned intents may then be used to further train the intent classification system.

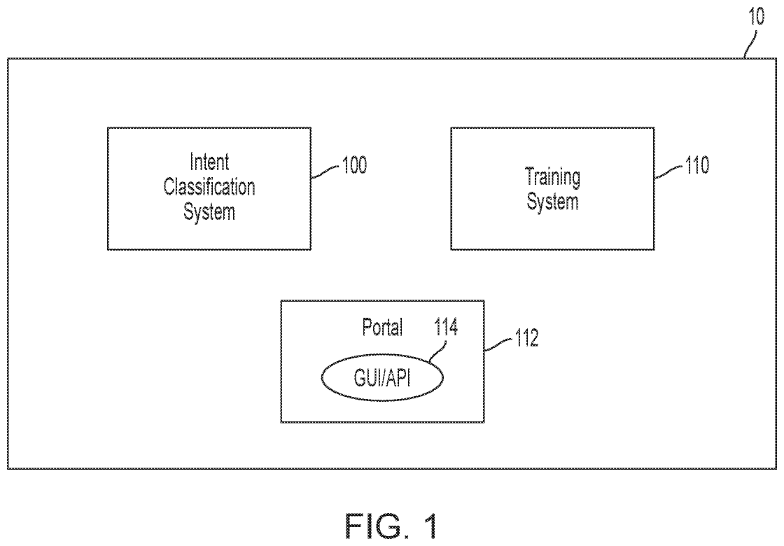

FIG. 1 is a block diagram of a chatbot system 10 according to one embodiment. The chatbot system 10 may include, without limitation, an intent classification system 100, training system 110, and administrator portal 112. The intent classification system 100 may include one or more machine learning models that are trained to identify a user intent based on a user query. For example, the intent classification system 100 may receive a query such as “What is my order status,” “I need to make a payment,” or “Can I get a refund on my item,” and output a predicted intent for the query, such as, for example, “order status,” “make payment,” or “get refund.”

The machine learning models used by the intent classification system 100 may include, for example, deep neural networks, shallow neural networks, and the like. The neural network(s) may have an input layer, one or more hidden layers, and an output layer. One or more of the neural networks may generate a set of context-aware embeddings (also referred to as features) from the user query. The embeddings may be word and/or sentence embeddings that represent one or more words of the user query as numerical vectors that encode the semantic meaning of the query. In this regard, the embeddings may also be referred to as semantic representations. In one example, the embeddings may be represented as a vector including values representing various characteristics of the word(s) in the query, such as, for example, whether the word(s) is a noun, verb, adverb, adjective, etc., the words that are used before and after each word, and/or the like.

In one embodiment, the embeddings may be generated by a language model that has been fine-tuned in a multi-task setting. The language model may be a Bidirectional Encoder Representations and Transformers (BERT) model having one or more embedding layers, each layer generating an embedding based on the query. The model may be fine-tuned by adjusting values of one or more learnable parameters of the language model for a particular task.

In one embodiment, the intent classification system 100 is configured to extract embedding features from the embeddings. The embedding features may be extracted, for example, from a subset of the embedding layers of the language model. The intent classification system 100 may use the extracted embedding features to predict a user intent. The predicted user intent may be used to generate an answer to the user query, for being returned to the requesting user.

The training system 110 may be configured to train one or more machine learning models of the intent classification system 100. In one embodiment, some or all components of the training system 110 may be incorporated into the intent classification system 100. The training system 110 may train or retrain (collectively referenced as “train”) the one or more machine learning models using training data. The training may include supervised and/or unsupervised training.

In one embodiment, a dataset of queries that are not recognized by the intent classification system 100 are used by the training system 110 to further train the machine learning models. The unrecognized queries may be queries for which the intent classification system 100 cannot predict corresponding intents within a threshold level of confidence. The unrecognized queries may be collected by the training system 110 and used to automatically or semi-automatically generate and recommend corresponding intents, and/or prompt the chatbot administrator to generate or accept recommended intents. Once an intent is generated for an unrecognized query, the query-intent tuple may be used to further train one or more machine learning models of the intent classification system 100.

The administrator portal 112 may be a server that serves a GUI or an application programming interface (API) (collectively referenced as GUI) 114 that a chatbot administrator may access using a user device, to configure and train the chatbot. The access of the portal 112 may be via the Internet using, for example, a web browser or an API.

In one embodiment, the GUI may provide a list of unrecognized queries collected by the training system 110, that appear organized into one or more groups/clusters. The queries within a particular group/cluster may be deemed to be similar to one another. The chatbot administrator may view the queries within the clusters and generate intents for one or more of the queries. In one embodiment, the GUI may provide a list of previously learned intents from which the administrator may select to associate the intent to an unrecognized query.

In some embodiments, the GUI may provide a template that the administrator may use to generate the intent and/or answer corresponding to the intent. The template may have one or more fields pre-filled based on keywords identified from the unrecognized query.

In some embodiments, the GUI may display a recommended intent for an unrecognized query, and prompt the administrator to accept or reject the recommended intent. The recommendation may be provided by the training system 110. The training system 110 may use one or more keywords in the unrecognized question to generate the recommended intent. In one embodiment, the recommended intent is generated using a generative language model.

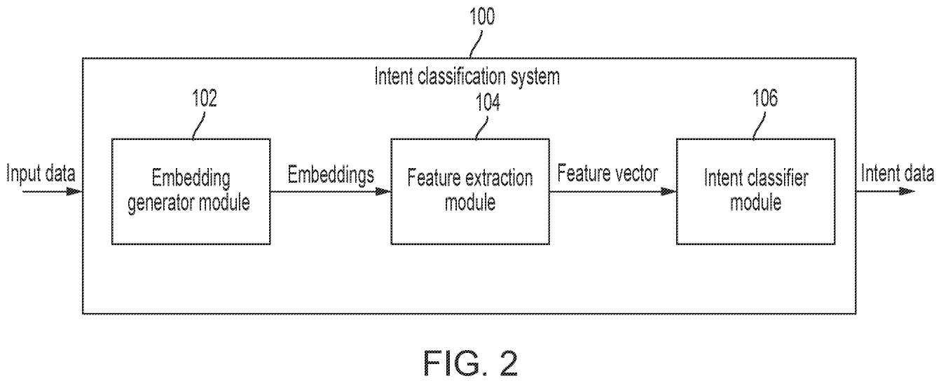

In one embodiment, the intent classification system 100 is implemented as described in U.S. application Ser. No. 17/361,114, filed on Jun. 28, 2021, entitled “Method and System for Generating an Intent Classifier,” the content of which is incorporated herein by reference. The intent classification system 100 according to this embodiment is described in further detail below with respect to FIGS. 2-9.

Example embodiments describe a method for training an intent classification system. The method includes receiving a question-intent tuple dataset comprising data samples, each data sample of the question-intent tuple dataset having a question, an intent, and a task. Further, the method obtains a pre-trained language model, the pre-trained language model being a pre-trained bidirectional encoder representations from transformers (BERT) model. Next, the method generates two fine-tuned language models by adjusting values of learnable parameters of the pre-trained language model. One fine-tuned model is generated in the masked language modelling fine-tuning module and referred to as the masked language modelling of the BERT language model (MLM-BERT language model). The other fine-tuned model, which fine-tunes the MLM-BERT language model, is the multi-task deep neural network of BERT language model (MT-DNN-BERT language model), generated in the multi-task deep neural network fine-tuning module. The method further generates an intent classification model using feature vectors extracted from an enterprise-specific dataset, the features being extracted from the output of the MT-DNN-BERT language model.

Various examples include a method for training an intent classification system. The method may receive a question-intent tuple dataset comprising data samples, each data sample of the question-intent tuple dataset having a question, an intent; and a task. Further, the method may obtain a pre-trained language model, the pre-trained language model being a pre-trained bidirectional encoder representations from transformers model. The pre-trained language model comprises a plurality of embedding layers comprising learnable parameters with values obtained with the pre-trained language model.

The method further generates a fine-tuned language model by adjusting values of the learnable parameters of the pre-trained language model. Adjusting values of the learnable parameters is performed by generating a plurality of neural network models using the question-intent tuple dataset. Each neural network model of the plurality of neural network models is trained to predict at least one intent of the respective question having a same task value of the tasks of the question-intent tuple dataset.

Further, the fine-tuned language model can generate embeddings for training input data. The input data comprises a plurality of data samples having questions and intents. Further, each task value represents a source of the question and the respective intent. Also, the method can generate feature vectors for the data samples of the training input data. The method can also generate an intent classification model for predicting at least one intent of the training input data using the feature vectors of the training input data.

In various examples, an intent classification computer program product by an intent classifier training process is disclosed. The computer program product comprises instructions stored in a non-transitory computer-readable medium which, when executed by at least one processor, causes the at least one processor to perform intent classification. The intent classifier training process can receive a question-intent tuple dataset comprising data samples, each data sample of the question-intent tuple dataset having a question, an intent; and a task. Further, the intent classification computer program product can obtain a pre-trained language model, the pre-trained language model being a pre-trained bidirectional encoder representations from transformers model. The pre-trained language model may comprise a plurality of embedding layers comprising learnable parameters with values obtained with the pre-trained language model.

The intent classification computer program product can further generate a fine-tuned language model by adjusting values of the learnable parameters of the pre-trained language model. Adjusting values of the learnable parameters can be performed by generating a plurality of neural network models using the question-intent tuple dataset. Each neural network model of the plurality of neural network models is trained to predict at least one intent of the respective question having a same task value of the tasks of the question-intent tuple dataset.

Further, the intent classification computer program product can use the fine-tuned language model to generates embeddings for training input data. The input data may comprise a plurality of data samples having questions and intents. Further, each task value represents a source of the question and the respective intent. Also, the intent classification computer program product can generate feature vectors for the data samples of the training input data. The intent classification computer program product can also generate an intent classification model for predicting at least one intent of the training input data using the feature vectors of the training input data.

In various examples, a system for training an intent classifier is disclosed. The system comprises a memory; and a processing device in communication with the memory, the processing device configured to execute instructions to cause the computing system to receive a question-intent tuple dataset comprising data samples, each data sample of the question-intent tuple dataset having a question, an intent; and a task. The processing device configured to execute instructions to further cause the computing system to obtain a pre-trained language model, the pre-trained language model being a pre-trained bidirectional encoder representations from transformers model. The pre-trained language model can comprise a plurality of embedding layers comprising learnable parameters with values obtained with the pre-trained language model.

The processing device configured to execute instructions to further cause the computing system to generate a fine-tuned language model by adjusting values of the learnable parameters of the pre-trained language model. Adjusting values of the learnable parameters can be performed by generating a plurality of neural network models using the question-intent tuple dataset. Each neural network model of the plurality of neural network models can be trained to predict at least one intent of the respective question having a same task value of the tasks of the question-intent tuple dataset.

Further, the fine-tuned language model generates embeddings for training input data. The input data comprises a plurality of data samples having questions and intents. Further, each task value represents a source of the question and the respective intent. Also, the processing device configured to execute instructions to further cause the computing system to generate feature vectors for the data samples of the training input data. The processing device configured to execute instructions to cause the computing system to generate an intent classification model for predicting at least one intent of the training input data using the feature vectors of the training input data.

In various examples, an non-transitory computer-readable medium storing instruction is disclosed. The instructions, when executed by at least one processor, causes the at least one processor to receive a question-intent tuple dataset comprising data samples, each data sample of the question-intent tuple dataset having a question, an intent; and a task. The instructions, when executed by at least one processor, causes the processor to obtain a pre-trained language model, the pre-trained language model being a pre-trained bidirectional encoder representations from transformers model. The pre-trained language model comprises a plurality of embedding layers comprising learnable parameters with values obtained with the pre-trained language model.

The instructions, when executed by at least one processor, further causes the processor to generate a fine-tuned language model by adjusting values of the learnable parameters of the pre-trained language model. Adjusting values of the learnable parameters can be performed by generating a plurality of neural network models using the question-intent tuple dataset. Each neural network model of the plurality of neural network models is trained to predict at least one intent of the respective question having a same task value of the tasks of the question-intent tuple dataset.

Further, the fine-tuned language model can generate embeddings for training input data. The input data comprises a plurality of data samples having questions and intents. Further, each task value represents a source of the question and the respective intent. Also, the instructions, when executed by at least one processor, further causes the processor to generate feature vectors for the data samples of the training input data. The instructions, when executed by at least one processor, causes the processor to generate an intent classification model for predicting at least one intent of the training input data using the feature vectors of the training input data.

FIG. 2 illustrates a data flow diagram of an example intent classification method for an inference task. The intent classification method for the inference task is performed by and implemented in an intent classification system 100, according to example embodiments. Since the example embodiment in FIG. 2 is for an inference task, all machine learning and artificial intelligence models are configured during training to perform the desired inference task. Training is a process in machine learning and artificial intelligence that generates a model with learnable parameters optimized on a training dataset to perform a task (e.g. generating a chatbot model that analyzes questions and categorizes the questions into intents for further processing). Inference, on the other hand, is a process in machine learning and artificial intelligence that uses the model generated in training to perform the task (e.g. using the generated chatbot model at run-time to analyze questions asked by users and categorize the questions into intents).

The intent classification system 100 receives input data of a question such as, “what is my order status,” “I need to make a payment,” “Can I get a refund on a duplicate payment?” etc. After processing the input data, the intent classification system 100 outputs intent data, classifying each question into an intent. In other words, the intent classification system 100 predicts an intent for the input data. For instance, predicted intents for the above questions may be “order status,” “making payment,” and “duplicate payment.” Further, each intent may represent multiple questions. For example, “How do I get my money back?”, “What's your refund policy?”, can both within the “refund” intent. The intent is a label to a question. It will be appreciated that the intent need not be a human-understandable text (e.g. order status), but it may be an alphanumeric string, a number, or any string representing the label.

Also, the term “question” may not include a question in the strict sense but may be a sentence making a statement. The question is a term to refer to a query asked by the user. For instance, a question may be “I want a refund” which can also have the “refund” intent. Further, the term “question” may be used interchangeably with the term “input data.”

The intent classification system 100 includes three modules: an embedding generator module 102, a feature extraction module 104, and an intent classifier module 106. The embedding generator module 102 includes an MT-DNN-BERT language model that uses machine learning and artificial intelligence. The MT-DNN-BERT language model is generated during training and is described in detail below. The output of the embedding generator module 102 comprises embeddings, each embedding being a three-dimensional matrix that includes token embeddings, described in detail below. Each embedding is a unique representation of the input data.

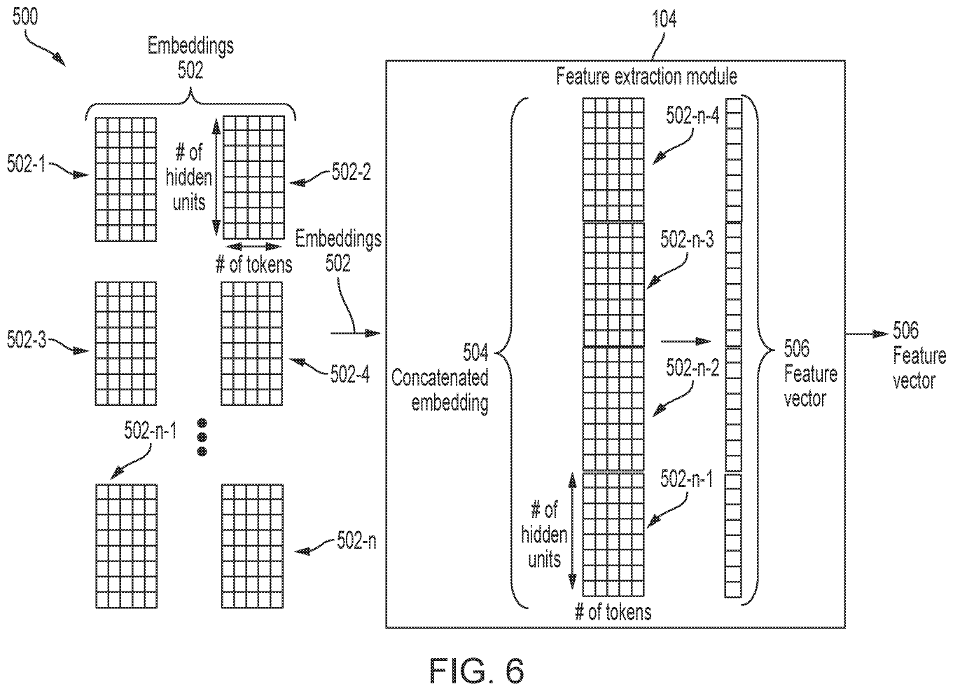

The feature extraction module 104 implements a method to extract a feature vector from the embeddings outputted by the embedding generator module 102. The method performed by the feature extraction module 104 is described in detail in FIG. 6. The intent classifier module 106 includes an intent classifier model that uses machine learning and artificial intelligence. The intent classifier model is generated during training. The intent classifier model receives feature vectors of the question from the feature extraction module 104 and predicts and outputs the intent.

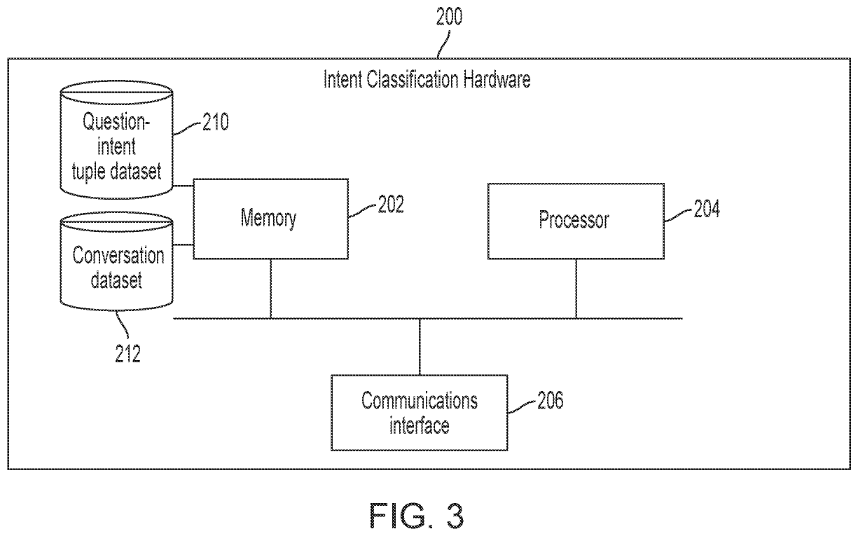

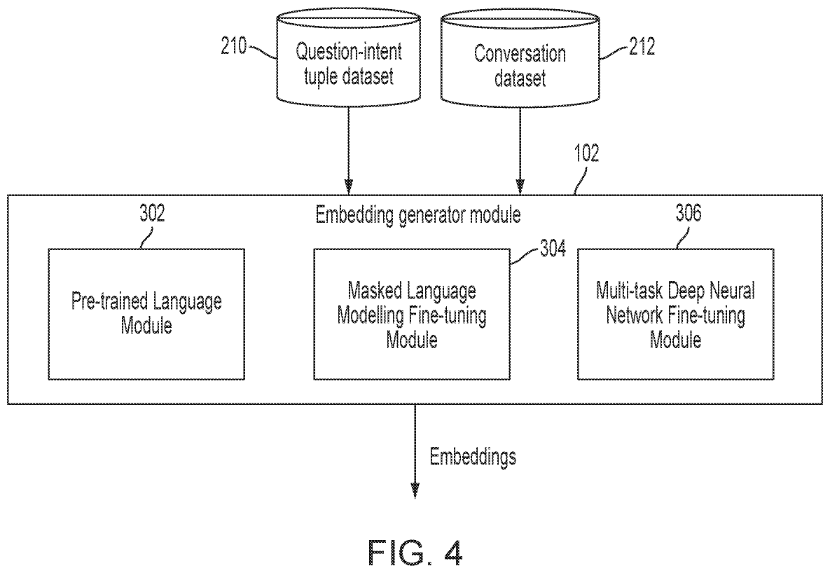

FIG. 3 is a schematic diagram of hardware implementing the intent classification system 100, according to example embodiments. The intent classification hardware 200 includes a memory 202, a processor 204, and a communications interface 206. A communication connection is implemented between the memory 202, the processor 204, and the communications interface 206, for example, using a bus. The processor 204 is configured to perform, when the computer program stored in the memory 202 is executed by the processor 204, steps of the intent classification method for an inference task as detailed in FIG. 2 and steps of the intent classification method during training as described in FIGS. 4, 5, 7, and 8 below.

The memory 202 can be a read-only memory (Read-Only Memory, ROM), a static storage device, a dynamic storage device, or a random access memory (Random Access Memory, RAM). The memory 202 may store a computer program. The memory 202 can be a non-transitory memory. The memory 202 can be external or removable in some examples. In an example, the memory 202 includes the question-intent tuple dataset 210. In an example, the memory 202 includes the conversation dataset 212. In other examples, the question-intent tuple dataset 210 is external to intent classification hardware 200.

The processor 204 can be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits. The processor 204 may be an integrated circuit chip with a signal processing capability. In an implementation process, steps of the intent classification method during training or inference making as described herein can be performed by an integrated logical circuit in a form of hardware or by an instruction in a form of a computer program in the processor 204. In addition, the processor 204 can be a general-purpose processor, a digital signal processor (Digital Signal Processor, DSP), an ASIC, a field-programmable gate array (Field Programmable Gate Array, FPGA) or another programmable logic device, a discrete gate or a transistor logic device, or a discrete hardware assembly. The processor 204 can implement or execute the methods, steps, and logical block diagrams that are described in example embodiments. The general-purpose processor can be a microprocessor, or the processor may be any conventional processor or the like. The steps of the intent classification method during training or inference making may be directly performed by a hardware decoding processor or may be performed by using a combination of hardware in the decoding processor and a computer program module. The computer program module may be located in a mature storage medium in the art, such as a random access memory, a flash memory, a read-only memory, a programmable read-only memory, an electrically erasable programmable memory, or a register. The storage medium is located in the memory 202. The processor 204 reads information from the memory 202, and completes, by using hardware in the processor 204, the steps of the intent classification method during training or inference making.

The communications interface 206 implements communication between the intent classification hardware 200 and another device or communications network using a transceiver apparatus, including but not limited to a transceiver. For example, the training dataset (i.e. the question-intent tuple dataset 210 or the conversation dataset 212) may be obtained using the communications interface 206.

It should be noted that, although the memory 202, the processor 204, and the communications interface 206 are shown in the intent classification hardware 200 in FIG. 3, in a specific implementation process, a person skilled in the art should understand that the intent classification hardware 200 may further include other components that are necessary for implementing normal running. In addition, based on specific needs, a person skilled in the art should understand that the intent classification hardware 200 may further include hardware components that implement other additional functions. In addition, a person skilled in the art should understand that the intent classification hardware 200 may include only a component required for implementing the embodiments, without a need to include all the components shown in FIG. 2.

FIG. 4 illustrates a block diagram of an example method of the embedding generator module during training. FIG. 2 describes the embedding generator module 102 during inference making (i.e. performing an inference task). As described above, the embedding generator module 102 includes the MT-DNN-BERT language model generated, through training, to achieve a specific task (e.g. predict intents). FIG. 4 describes an example method for generating, through training, the MT-DNN-BERT language model. The training requires training datasets, which contain texts (e.g. questions, interchangeably, input data). Two training datasets can be used to generate the MT-DNN-BERT language model, the question-intent tuple dataset 210 and the conversation dataset 212. The question-intent tuple dataset 210 is a labelled dataset consisting of data samples, each data sample having a question, an intent, and a task. The questions are text questions asked by users of chatbots. The intents are unique identifiers representing coherent groups of questions, as described above. Each question is usually mapped to a single intent. These questions and intents may be collected from different sources (e.g. chatbots) across different domains and industries (e.g. finance, logistics, education, transportation, etc.). The data samples, including questions and intents, of each source are assigned a unique task. Therefore, each data sample includes a question, an intent for the question, and a task representing the source (chatbot from an enterprise). Typically, data samples collected from a same source (same source chatbot) have a same task value. Data samples collected from the same industry are from the same source, hence, have a same task value. In other words, the question-intent tuple dataset 210 comprises a plurality of sub-datasets; each sub-dataset is collected from a source. For example, data samples collected from chatbot 1 may be assigned with a task value of 1, data samples collected from chatbot 2 may be assigned with a task value of 2, etc. The conversation dataset 212 is an unlabelled dataset that comprises data samples of conversation messages collected from users of chatbots.

The embedding generator module 102 and its components are now described. It receives training datasets as input and outputs embeddings for data samples. The embedding generator module 102 includes three modules, a pre-trained language module 302, a masked language modelling fine-tuning module 304, and a multi-task deep neural network fine-tuning module 306. The pre-trained language module 302 includes a pre-trained language model that uses machine learning and artificial intelligence. The pre-trained language model may be BERT, which is a bidirectional encoder representations from transformers proposed by Devlin, Jacob, et al. “Bert: Pre-training of deep bidirectional transformers for language understanding.” arXiv preprint arXiv:1810.04805 (2018), incorporated by reference herein in its entirety.

The pre-trained language model, BERT in some examples, is a machine-learning based embedding generation technique. The pre-trained language model comprises a plurality of embedding layers, each generating an embedding. Each embedding layer performs computations on the embedding of the previous embedding layer. Therefore, the pre-trained language model receives a word or a collection of words and generates embeddings for each word and the collection of words. Each question of a data sample of the question-intent tuple dataset 210 or a data sample of the conversation dataset 212 may be called a sentence, which is a plurality of words. The words of a sentence typically have a relationship to each other based on their relative positions in a sequence of words (e.g., in a sentence). The sentence may also include non-words, such as symbols (e.g., “?”, “!”, “@”, “#”, and other punctuation marks), whitespace or numeric characters.

The pre-trained language module 302 can also include a tokenizer (not shown) that tokenizes each sentence, wherein tokenization is a technique that separates the sentence into units referred to as tokens. For example, the sentence may be the text string “Hello, check order!”. This sentence may be tokenized into the tokens “Hello”, “check”, and “order”. Each token is represented with a unique identifier (ID). The pre-trained language model may further process the tokenized sentence into a dense vector representation of each token, referred to as a token embedding. Therefore, an embedding is a numerical matrix representation of a sentence. Each embedding comprises a plurality of token embedding. Each token embedding is a numerical vector representation of a token. Further, each embedding has a separate token called a classification token representing the sentence as a whole.

The tokenized words are provided to the pre-trained language model to generate embeddings. Embeddings of semantically related tokens are closer to each other in a vector space (where the vector space is defined by all embeddings generated from sentences). For example, a first embedding representing the token “Hello” and a second embedding representing the token “Hi” should be closer to each other in the vector space when compared to the distance between the first embedding representing the token “Hello” and a third embedding representing the token “Dog.”

The dimensionality of each embedding depends on the pre-trained language model used to generate the embedding; in particular, the vector length of the token embedding depends on the number of hidden units per embedding layer of the pre-trained language model. The dimensionality of all token embeddings may be the same. An example embodiment can use BERT-Large Uncased (24 embedding layers, 1024 hidden units), BERT-Large Cased (24 embedding layers, 1024 hidden units), BERT-Base Uncased (12 embedding layers, 768 hidden units), BERT-Large Uncased (24 embedding layers, 1024 hidden units), BERT-Base Cased (12 embedding layers, 768 hidden units), and BERT-Large Cased (24 embedding layers, 1024 hidden units), all these pre-trained language models are generated by Google™, and available at (Google Research, https://github.com/google-research/bert, Mar. 11, 2020), all of which are incorporated by reference herein in their entirety. It is understood that the disclosed pre-trained language models can be used in some examples. Other pre-trained language models can be used in other examples.

The pre-trained language model comprises a plurality of learnable parameters optimized through training on general, perhaps public, training datasets. However, the model can be fine-tuned to better understand a particular use of language in a specific domain (e.g. finance, education, etc.). The process of fine-tuning adjusts the values of the learnable parameters of the pre-trained language model. In example embodiments, the pre-trained language model is fine-tuned twice, once in the masked language modelling fine-tuning module 304 to generate the masked language modelling of BERT language model (referred to as MLM-BERT language model). The MLM-BERT language model can be further fine-tuned in the multi-task deep neural network fine-tuning module 306 to generate the multi-task deep neural network of BERT language model (referred to as MT-DNN-BERT language model).

The masked language modelling fine-tuning module 304 uses the conversation dataset 212 as the training dataset for fine-tuning the pre-trained language model. The masked language modelling fine-tuning module 304 tokenizes the conversation dataset's 212 data samples to generate tokenized data samples of the conversation dataset 212. Further, the masked language modelling fine-tuning module 304 masks at least one token of the tokenized data samples. While fine-tuning the pre-trained language model to generate the MLM-BERT language model, the pre-trained language model is tasked to predict the masked token, and a masked language model loss is computed. The masked language model loss is computed for the pre-trained language model based on the predicted token and the respective token of the data sample of the conversation dataset 212. The respective token of the data sample is the token without the mask. The masked language model loss is a loss function calculated through forward propagation of the tokenized data samples with masked tokens. The masked language model loss is backpropagated through the pre-trained language model to adjust values of learnable parameters of the pre-trained language model and reduce the masked language model loss. This process is done iteratively. With each iteration, the masked language model loss decreases until the values of the learnable parameters of the pre-trained language model are optimized on the conversation dataset 212. After the pre-trained language model is fine-tuned in the masked language modelling fine-tuning module 304, such fine-tuned pre-trained model is referred to as the MLM-BERT language model.

After generating the MLM-BERT language model, the processor 204 provides the MLM-BERT language model to the multi-task deep neural network fine-tuning module 306 for a second fine-tuning stage. The multi-task deep neural network fine-tuning module 306 uses the question-intent tuple dataset 210 to fine-tune the MLM-BERT language model. The question-intent tuple dataset 210 includes data samples of questions, intents, and tasks. The multi-task deep neural network fine-tuning module 306 generates a multi-task deep neural network model for the tasks in the question-intent tuple dataset 210. The multi-task deep neural network model consists of a plurality of neural network models; each neural network model is trained on data samples of a unique task value of the tasks of the question-intent tuple dataset 210. For instance, if there are I data samples, each data sample has a task, so I task values. The I task values are comprised of T unique task values. Therefore, the multi-task deep neural network model consists of T neural network models.

The multi-task deep neural network fine-tuning module 306 implements a method to generate the multi-task deep neural network model. Example embodiments include training the neural network models in parallel where all neural network models, each for a unique task value, are trained concurrently. Other example embodiments include training the neural network models in series by generating a neural network for one unique task value at a time.

Neural networks will be briefly described in general terms. A neural network can include multiple layers of neurons, each neuron receiving inputs from a previous layer, applying a set of weights to the inputs, and combining these weighted inputs to generate an output, which can, in turn, be provided as input to one or more neurons of a subsequent layer.

A layer of neurons uses filters to define the relationship between the outputs of the neurons of the previous layer and the outputs of the neurons of the current layer. A layer of the neural network receives data input, usually in the form of a data array of known dimensions. By applying the set of filters (layers) to the data input, each layer generates data output, typically a data array with known dimensions. A filter comprises a set of weights (also learnable parameters).

In the example of a neural network, training a neural network involves learning or determining the appropriate weight values throughout the network. After being optimally trained to perform a given inference task, the neural network's weights will not all contribute equally to the final inference outputs. Some weights will have high value due to their high contribution, while others will have low value due to their low contribution.

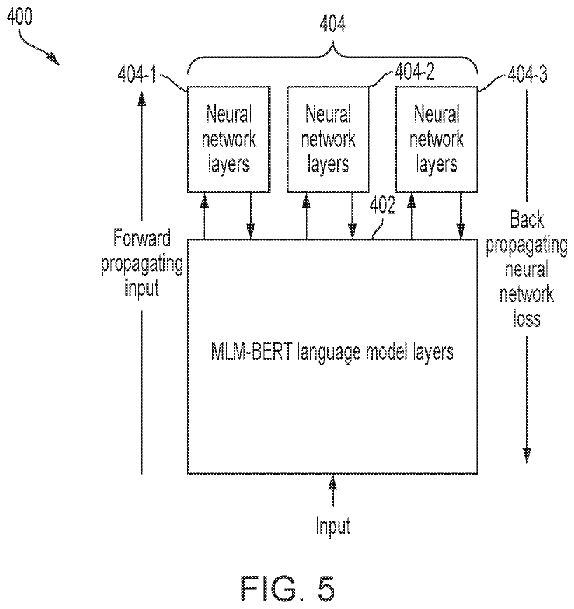

FIG. 5 is a data flow diagram illustrating the fine-tuning method performed in the multi-task deep neural network fine-tuning module 306. The fine-tuning method 400 is performed in the multi-task deep neural network fine-tuning module 306, which includes MLM-BERT language model layers 402 and a plurality of neural network layers 404. Each neural network layers 404-1, 404-2, 404-3 belongs to, and part of, a respective neural network model trained to predict intents from questions. The multi-task deep neural network fine-tuning module 306 receives data samples of the question intent tuple dataset 210 as input and generates a neural network model for every unique task value. The input is forward propagated from a first layer of the MLM-BERT language model layers 402 to a last layer of one of the neural network layers (404-1, 404-2, and 404-3), depending on the respective network model being trained. As described above, the pre-trained language model includes a plurality of embedding layers. Therefore, the MLM-BERT language model, which is a fine-tuned version of the pre-trained language model, also includes embedding layers, referred to as the MLM-BERT language model layers 402.

In the multi-task deep neural network fine-tuning module 306, each neural network model has a plurality of layers, a subset of layers of the plurality of layers being shared among all neural network models. This shared subset of layers is the layers of the MLM-BERT language model layers 402. Further, each neural network model has a subset of layers specific to the unique task value the neural network model is trained on. The subset of layers specific to a task is not shared among the neural network models; such subsets of layers are depicted as neural network layers 404-1, 404-2, and 404-3.

For each neural network model, a neural network loss for the neural network is computed based on the neural network model's intent prediction of a question of the data sample and the respective intent of the question. The neural network loss is backpropagated, adjusting values of learnable parameters of the respective neural network model layers 404-1, 404-2, or 404-3, and the learnable parameters of the MLM-BERT language model.

When all values of learnable parameters of neural network models are optimized, fine-tuning the MLM-BERT language is completed. The generated model is referred to as the MT-DNN-BERT language model. It will be appreciated that example embodiments can describe the sequence of generating the MLM-BERT language model and the MT-DNN-BERT language model differently. For instance, the MT-DNN-BERT language model can be generated by fine-tuning the pre-trained language model; then, the MLM-BERT language model can be generated by fine-tuning the MT-DNN-BERT. In other example embodiments, only one fine-tuning stage is performed; for instance, only the MT-DNN-BERT language model is generated by fine-tuning the pre-trained language model. In another example embodiment, only the MLM-BERT language model is generated by fine-tuning the pre-trained language model. At this stage, the operations performed in the embedding generator module 102 are described, and the MT-DNN-BERT language model is trained. The MT-DNN-BERT language model can generate embeddings when applied to data samples during training or input data during inference making. This MT-DNN-BERT language model can be included in the embedding generator module 102 and used for inference making, as described in FIG. 2.

FIG. 6 is an illustrative diagram of the method performed by the feature extraction module 104. FIG. 4 and FIG. 5 described how the MT-DNN-BERT language model included in the embedding generator module 102 of FIG. 2 is generated. Referring to FIG. 2, embeddings 502 generated for input data are provided to a feature extraction module 104 to extract feature vectors 506. The illustrative diagram 500 describes how a feature vector 506 is extracted from embeddings 502 generated for input data (e.g., a question). Each embedding is the output of an embedding layer (502-1, 502-2, . . . , 502-n) of the MT-DNN_BERT language model. For instance, if example embodiments use the pre-trained language model BERT-Base Uncased (12 embedding layers, 768 hidden units) described above, then there are 12 embedding layers. Therefore, the output of the respective MT-DNN-BERT model can contain 12 embeddings. Each embedding (502-1, 502-2, . . . , 502-n) has a plurality of token embeddings, where there is an embedding for each token of the input data. Each token embedding is a vector of size depending on the number of hidden units of the pre-trained language model. If the BERT-Base Uncased is used, then each token embedding has a length of 768 elements.

The feature extraction module 104 receives all embeddings 502. In example embodiments, the feature extraction module 104 uses the embeddings of the last four layers before the last layer (i.e. 502-n−1, 502-n−2, 502-n−3, and 502-n−4). In other words, if the pre-trained language model has 12 embedding layers, then the feature extraction module 104 uses embeddings of embedding layers 8, 9, 10, and 11. The feature extraction module 104 concatenates such embeddings to generate the concatenated embedding 504. The concatenated embedding 504 includes an embedding for each token. Each token embedding of the concatenated embedding 504 is a result of concatenating token embedding of a plurality of embeddings 502 (i.e., embeddings of 4 layers in this example). Therefore, if each token embodiment is of size 768, then each token embedding of the concatenated embedding 504 is of size 768×4=3072. The feature vector 506 is extracted from the concatenated embedding 504 by computing the average of all token embeddings of the concatenated embedding 504. For instance, if the concatenated embedding 504 is of size 3072×5, in the scenario where there are 5 token embeddings, then the feature vector 506 would be of size 3072×1. The feature vector 506 is the output of the feature extraction module 104 and is used to train an intent classifier model in the intent classifier module 106.

It is understood that using the last four layers before the last layer (i.e. 502-n−1, 502-n−2, 502-n−3, and 502-n−4) to generate the concatenated embedding 504 was just an example. Different embedding layers and number of embedding layers may be concatenated to generate the concatenated embedding 504.

Referring back to FIG. 2, the feature vector 506 is used in the intent classifier module 106. In FIG. 2, the intent classifier model is configured through training to classify feature vectors 506 into intents. Training the intent classifier model can be performed using any suitable classifier, such as any support vector machine (SVM), neural network, or any other suitable algorithm. In some embodiments, the intent classifier module 106 implements an SVM algorithm to train the intent classifier model. Training the SVM may require a labelled training dataset since SVM is a supervised machine learning algorithm.

Example embodiments include methods using the question-intent tuple dataset 210 to train the SVM. In such examples, the task value of the question-intent tuple dataset 210 may not be used, and the SVM is trained to classify the questions into intents. Example embodiments can use a dataset other than the question-intent tuple dataset 210 for training the SVM. The dataset for training the SVM may be an enterprise-specific dataset. The enterprise-specific dataset may include questions and intents specific to the industry of the enterprise developing the chatbot (e.g., finance, education, logistics, transportation, etc.). In example embodiments, the enterprise-specific dataset may be collected by the enterprise that is developing the chatbot, making the chatbot even more tailored towards the needs of the enterprise.

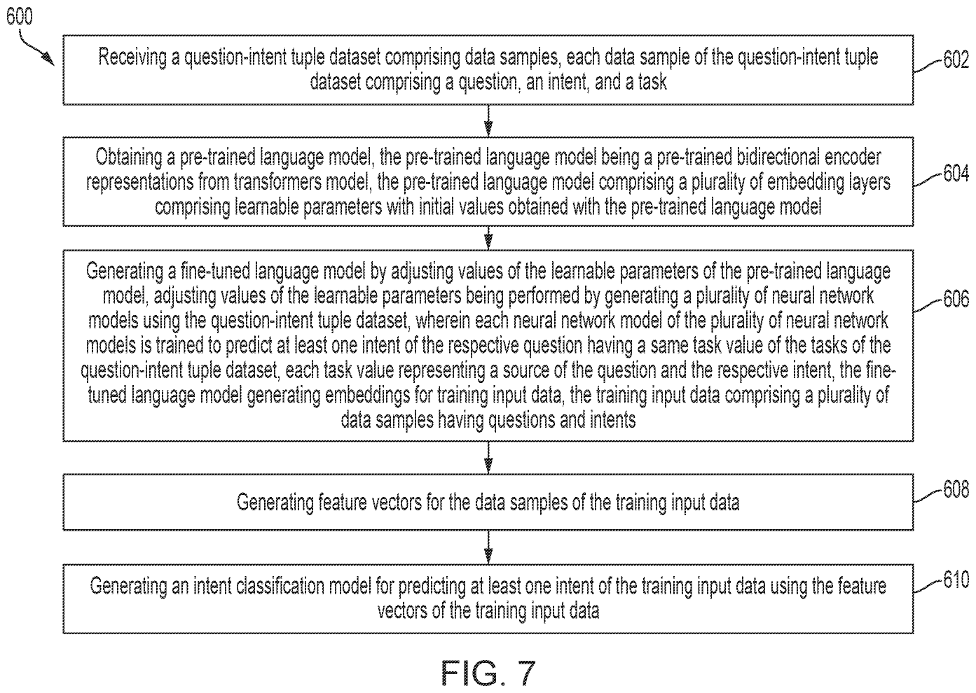

FIG. 7 is a flowchart of an example method 600 for generating an MT-DNN-BERT language model from a pre-trained language model without generating the MLM-BERT language model. The method 600 generates an MT-DNN-BERT language model from a pre-trained language model by fine-tuning the pre-trained language model instead of fine-tuning the MLM-BERT language model.

The method 600 starts at step 602 where the multi-task deep neural network fine-tuning module 306 receives a question-intent tuple dataset 210 comprising data samples. As described before, each data sample of the question-intent tuple dataset 210 includes a question, an intent, and a task. The method 600 then proceeds to step 604.

At step 604, the multi-task deep neural network fine-tuning module 306 obtains a pre-trained language model from the pre-trained language module 302. The pre-trained language model is a pre-trained bidirectional encoder representations from transformers model comprising a plurality of embedding layers. When inputting data samples to the pre-trained language model, the method 600, through the multi-task deep neural network fine-tuning module 306, generates embeddings for each data sample. The method 600 then proceeds to step 606.

At step 606, the multi-task deep neural network fine-tuning module 306 generates a fine-tuned language model, which is the MT-DNN-BERT language model in this example embodiment. The MT-DNN-BERT language model is generated by adjusting values of learnable parameters (fine-tuning) of the pre-trained language model. This fine-tuning is performed by generating a plurality of neural network models using the question-intent tuple dataset 210. The number of neural network models can be the number of unique task values. Then, each neural network model of the plurality of neural network models is trained to predict intents of questions having a unique task value. In other words, each neural network model is trained to predict the intents of the questions having a same task value. Once the multi-task deep neural network fine-tuning module 306 has generated the fine-tuned language model, the method proceeds to step 608.

At step 608, the method 600 starts the stages of training the intent classifier model, which starts by extracting features. The method 600 can use any dataset comprising questions and intents to train the intent classifier model. Such dataset can be referred to as training input data. The extraction module 104 generates a feature vector for every data sample of the training input data. The method 600 then proceeds to step 610. At step 610, the intent classifier module 106 uses the feature vectors of the data samples of the training input data and generates an intent classification model for predicting the intents of the training input data.

The intent classification model, generated at step 610, can be used for inference making in chatbots to classify the questions asked by users into intents. Further, the chatbots can use the intents to answer the user's questions or connect the user to a person who can answer the user.

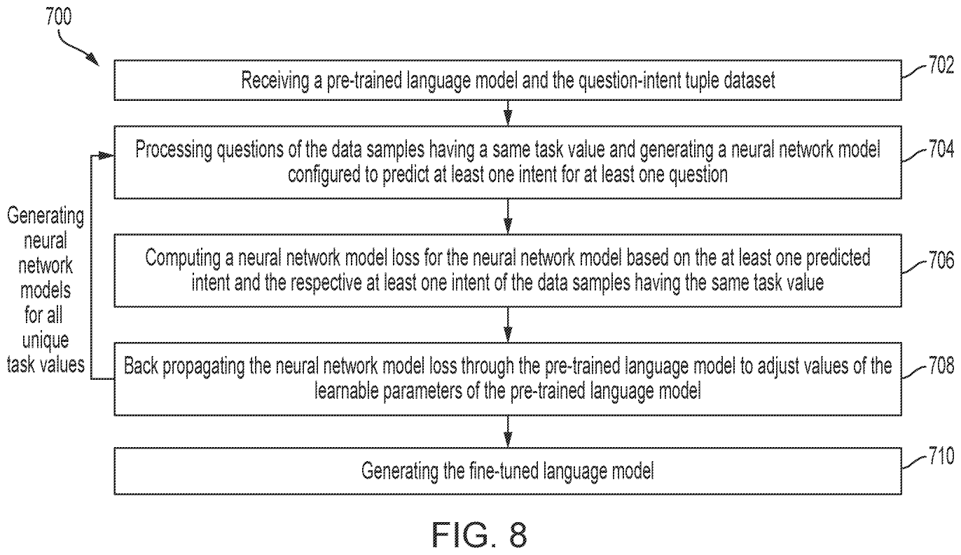

FIG. 8 is a flowchart of an example method 700 for training a plurality of neural network models used in generating the MT-DNN-BERT language model described in FIG. 7. Method 600 in FIG. 7 described the method for generating the MT-DNN-BERT language model and explained, without going into detail, that generating the MT-DNN-BERT language model includes training a plurality of neural network models. Method 700 describes in detail the part of method 600 with respect to training the plurality of neural network models. The plurality of neural network models collectively referred to as the multi-task deep neural network model as described above.

The method 700 starts at step 702 where the multi-task deep neural network fine-tuning module 306 receives a pre-trained language model and the question-intent tuple dataset 210.

At step 704, the multi-task deep neural network fine-tuning module 306 processes questions of the data samples of a same task value and generates a neural network model configured to classify questions into intents for data samples of the same task value.

Each neural network model comprises a plurality of layers. A first subset of layers of the plurality of layers is shared among all neural network models. However, a second subset of layers of the plurality of layers is specific to the neural network model for the same task value being processed. The first subset of layers and the second subset of layers are disjoint.

The method 700 inputs the quested of the data samples of the question-intent tuple dataset 210 of the same task value into the neural network model to forward propagate the questions of the data samples with the same task value and generate the predicted intent for each question. The method 700 then proceeds to step 706.

At step 706, the multi-task deep neural network fine-tuning module 306 computes a neural network model loss for the neural network model based on the predicted intents and the respective intents of the data samples with the same task value. Once the neural network model loss is computed, the method 700 proceeds to step 708.

At step 708, the multi-task deep neural network fine-tuning module 306 back propagates the neural network language model loss through the pre-trained language model to adjust values of learnable parameters of the pre-trained language model. Steps 706-708 are repeated until the values of the learnable parameters of the pre-trained language model are optimized. The method 700 continues until the neural network models are generated for all unique task values.

At step 710, after the multi-task deep neural network fine-tuning module 306 generates neural network models for all unique task values, the pre-trained language model whose values of learnable parameters were continuously adjusted and optimized becomes the fine-tuned language model, which in this example is the MT-DNN-BERT language model. In other words, at step 710, the multi-task deep neural network fine-tuning module 306 generates the MT-DNN-BERT language model.

The generated MT-DNN-BERT language model at step 710 is used to generate embeddings. This MT-DNN-BERT language model can be incorporated with any subsequent machine learning algorithms to train a model for classifying questions into intents. It can also be used in chatbots during inference making for extracting embeddings of input data.

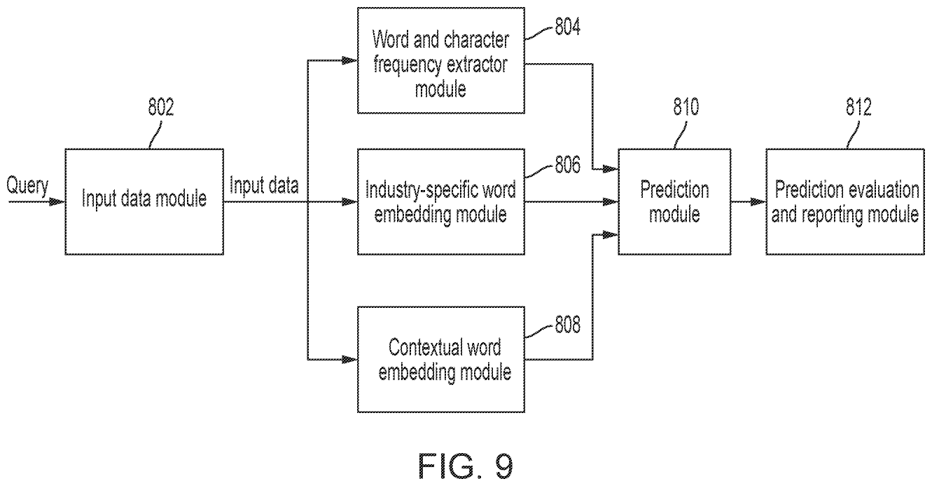

FIG. 9 is an example chatbot system 800 implementing modules of the intent classification system 100 of FIG. 2. The chatbot system 800 receives a query from a user through the input data module 802, which may implement a graphical user interface. The input data module 802 outputs input data, which is the query in text format. The query may be a text typed directly into the graphical user interface of the input data module 802, or a spoken query, which is converted to text through a speech-to-text converter (not shown). The input data may be in the language the chatbot system 800 is trained with, or the input data may also be in a different language but translated through a translation module (not shown) into the language of the chatbot system 800. The input data may include a plurality of words representing the user question in the query, for example, “Has my package been shipped yet?”, “When will my package arrive”, etc.

The input data 802 may not be processed directly by subsequent modules of the chatbot system 800 as words but may be converted to numerical representation in numerical representation modules, including word and character frequency extractor module 804, industry-specific word embedding module 806, and contextual word embedding module 808. Example embodiments of chatbot systems 800 may not need to have all the mentioned numerical representation modules (804, 806, and 808).

The character frequency extractor module 804 receives the input data and may represent how frequently each word in the input data and each n-character sequence appear in the chatbot system's 800 training datasets. No word analysis with respect to the relationships between words can be performed in the character frequency extractor module 804. Further, the character frequency extractor module 804 can provide the prediction module 812, responsible for generating answers, with information to improve the accuracy of answers. The output of the character frequency extractor module 804 differs between chatbots as it is mainly influenced by the training datasets used by the enterprise implementing the chatbot system 800.

The industry-specific word embedding module 806 receives the input data and generates embeddings for the input data. The embeddings generated by the industry-specific word embedding module 806 are influenced by the industry of the enterprise implementing the chatbot system 800. For instance, a word's embeddings of a telecommunications industry would have different embeddings than those in the finance or transportation industries.

The contextual word embedding module 808 also receives input data and generates embeddings for the input data, but such embeddings capture the contextual meaning of words in the input data. Unlike industry-specific word embedding module 806, the contextual word embedding module 808 dynamically adjusts the word embeddings based on other words in the input data. The contextual word embedding module 808 enables the prediction module 812 to better understand the specific meaning of a word in the input data. For example, the meaning of the word “park” varies between “where can I park my car?” and “where is the closest national park.”

The prediction module 810 can receive input from the word and character frequency extractor module 804, the industry-specific word embedding module 806, and the contextual word embedding module 808, and predicts answers. The prediction module 810 can include a plurality of modules, including the feature extraction module 104 and the intent classifier module 106 of the intent classification system 100 described above. The predicted answers of the chatbot system 800 differ from one chatbot system 800 to another, depending on the enterprise's industry implementing the chatbot system 800, particularly the training datasets used in training models of the chatbot system 800. The prediction module 810 also outputs confidence values for each predicted answer indicating correctness likelihood.

The predicted answers are provided to the prediction evaluation and reporting module 812, which determines which predicted answer of the predicted answers to provide to the user, if any. Example embodiments may describe the prediction evaluation and reporting module 812 to include a plurality of confidence thresholds to compare with each predicted answer's confidence value. The confidence values are compared to a first threshold. If any confidence values are greater than the first threshold, the respective predicted answer with the highest confidence value is reported to the user. However, if none of the confidence values is greater than the first threshold, the prediction evaluation and reporting module 812 compares the confidence values to a second threshold. If any questions are greater than the second threshold, the prediction evaluation and reporting module 812 requests clarifications from the user. The clarification request may be reported to the user along with at least one of the predicted answers with a confidence value above the second threshold. If none of the confidence values is above the second threshold, the prediction evaluation and reporting module 812 reports to the user that the question in the query was not understood.

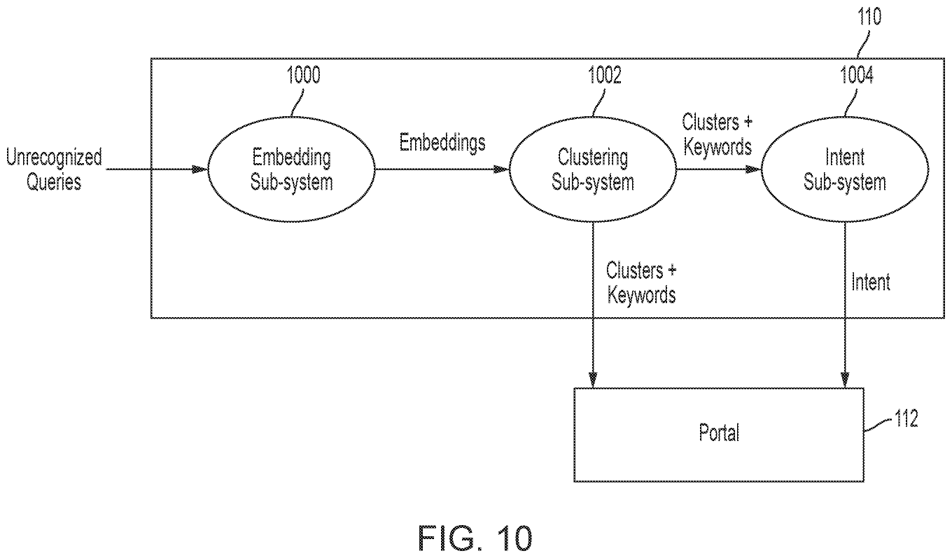

FIG. 10 is a conceptual block diagram of the training system 110 according to one embodiment. In one embodiment, the training system 110 includes an embedding sub-system 1000, clustering sub-system 1002, and intent sub-system 1004. Although the sub-systems 1000-1004 of FIG. 10 are described as separate components, a person of skill in the art should recognize that the sub-systems may be combined into a single sub-system, or one or more of the sub-systems be further subdivided into additional sub-systems as will be appreciated by a person of skill in the art.

The embedding sub-system 1000 may be configured to receive a dataset of unrecognized user queries and convert each query into a semantic representation. In this regard, the embedding sub-system 1000 may interface with the embedding generator module 102 and the feature extraction module 104 of the intent classification system 100, for generating extracted embedding features for each query. As described above with respect to the intent classification system 100, sentence embeddings may be extracted by passing an unrecognized user query through a language model that encodes semantic word meaning (e.g. the MT-DNN-BERT language model), concatenating the model weights for a combination of the embedding layers of the model, and computing the average of the word vectors for each token (e.g. token embeddings) in the query.

In one embodiment, the clustering sub-system 1002 receives the semantic representations (e.g. the extracted embedding features) for grouping the queries into one or more clusters. In this regard, the clustering sub-system 1002 may employ a clustering algorithm such as Hierarchical Density-Based Spatial Clustering of Applications with Noise (HDBSCAN), with the minimum cluster size set to three. Other cluster sizes are also possible, as well as other clustering algorithms, including Density-Based Spatial Clustering of Applications (DBSCAN), k-means algorithm, hierarchical clustering algorithm, or the like.

In one embodiment, the clustering algorithm is configured to recognize queries that are semantically similar to one another, and group them into a cluster. Clusters may be identified using a cluster number. Queries that belong to the same cluster may be identified via the same cluster number. A query that is not able to be grouped into a cluster may be assigned to a noise group that may be discarded.

In one embodiment, the clustering sub-system 1002 is configured to generate a cluster summary for each cluster. The cluster summary may include titles and/or keywords generated or identified for the cluster. For example, the clustering sub-system 1002 may identify keywords that occur more frequently within the cluster than other clusters, and include the identified keyword(s) as the cluster summary. In this regard, an algorithm such as Term Frequency-Inverse Document Frequency (TF-IDF) may be invoked to compare unigrams of the words contained in the queries of each cluster, against the unigram of words contained in the queries of the other clusters, and identify the frequently occurring keywords for each cluster to be included into the cluster summary.

In another example, the cluster summary/title may be generated via an abstractive summarization model or a generative language model (collectively referred to as a summarization model). For example, the summarization model may be invoked generate novel text that is predicted to accurately summarize each cluster's semantic meaning. The novel text may include words that are new to the cluster (e.g. do not appear in any of the queries for the cluster). One or more of the words output by the summarization model may be used as the cluster summary.

In one embodiment, the summarization model is trained via queries that have known intent titles (e.g. intents and queries that have already been approved by the chatbot administrator). Specifically with respect to the abstractive model, the model may be fine-tuned by sending the approved queries through the model and having it generate a summary that aims to be close to the corresponding intent title. The loss between the generated summary and the actual intent title may be backpropagated through the model to optimize the model weights.

With respect to the generative language model, a prompt may be sent into the model at inference in order to generate a cluster summary. The prompt may include a description in plain text of the task of generating intent titles, followed by zero or several examples of approved queries and corresponding intent titles. The prompt may also include queries of a given cluster with a placeholder left for the cluster title. The model's generated text may then used as the title for the given cluster.

Information about the clusters including the cluster summaries and/or the identified keywords may be provided to the administrator portal 112 for access by the chatbot administrator via the administrator's end user device. The information about the clusters may further include, for example, the number clusters generated for the unrecognized queries, the size of the clusters (e.g. number of queries in each cluster), the queries contained in the clusters, and/or the like.

In one embodiment, the administrator's end user device may interact with the GUI/API 114 provided by the administrator portal 112 for viewing and navigating through the various clusters in an organized manner. Thus, the chatbot administrator need not search through the list of unrecognized questions manually for identifying similar groups.

The GUI/API 114 may further be invoked for assigning intents/answers for an unrecognized question. In this regard, the chatbot administrator may select an intent amongst existing intents, or generate a new intent for assigning to the query.

In some embodiments, the intent/answer to be assigned to an unrecognized query may be automatically recommended by the intent sub-system 1004. For example, the intent sub-system 1004 may maintain a database of template answers that may be queried (e.g. based on a keyword associated with the cluster) for suggesting a format and/or substance of the answer for the query. For example, the system can perform a semantic similarity computation between the string containing the concatenated keywords (or any other manifestation of cluster description) and all the titles of the answer templates in an internal database.

In other examples, the intent sub-system may include a generative language model such as, for example, Generative Pre-trained Transformer 3 (GPT-3) for generating new intents/answers based on existing intents/answers. The newly generated intents/answers may be output to the chatbot administrator via the GUI/API 114 as suggested intents/answers for an unrecognized query. In some embodiments, an intent title for the suggested intents/answers is also output by the intent sub-system. The suggested intent title may be generated using one or more words of the cluster summary that describes the cluster that includes the unrecognized query.

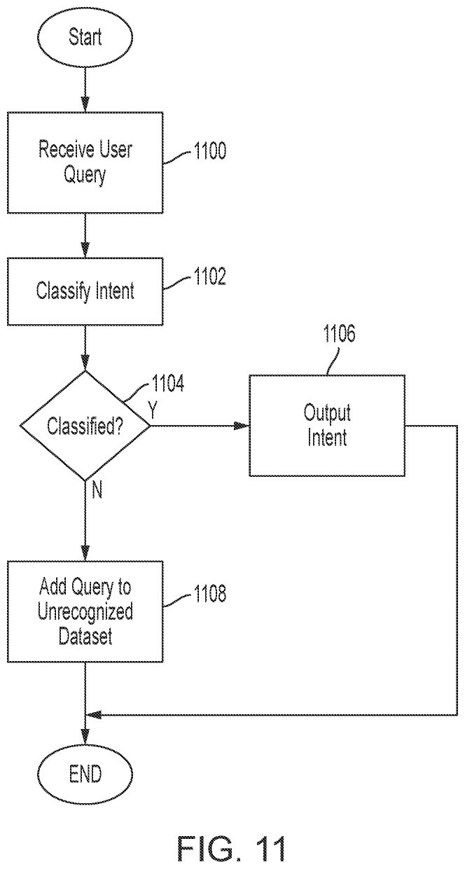

FIG. 11 is a flow diagram of a process for classifying intents according to one embodiment. The process starts, and in act 1100, a user query is received, and in act 1102, an attempt is made to classify the intent of the query. In one embodiment, the embedding generator module 102 generates context-aware embeddings from the user query via a language model fine-tuned for use in a multi-task setting. The feature extraction module 104 may extract embedding features from the generated embeddings. The intent classifier module 106 may predict the intent of the query based on the extracted embedding features. In one embodiment, a confidence of the prediction is output along with the predicted intent.

In act 1104, a determination is made as to whether the intent of the query can be classified within a threshold level of confidence.

If the answer is YES, the predicted intent is output in block 1106. The predicted intent may be used by the chatbot system 10, 800 for formulating an answer based on the intent.

If, however, the intent of the query cannot be classified within a threshold level of confidence, the query may be deemed to be unrecognized. The unrecognized query may be added to a dataset of unrecognized queries in act 1108.

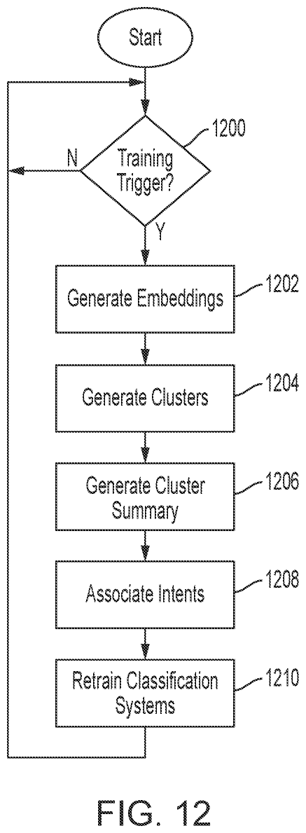

FIG. 12 is a flow diagram of a process for training a machine learning model of the intent classification system 100 using a dataset of unrecognized queries according to one embodiment. The process starts, and in act 1200, a determination is made as to whether a training trigger has been detected (e.g. by the training system 110) to train the machine learning model. The training trigger may be invoked upon receipt of a threshold number of unrecognized queries. In some embodiments, the training trigger is invoked at set times (e.g. at 12 am every day), after set time periods (e.g. after every 48 hours), and/or the like.

In response to detecting the training trigger, embedding features may be extracted for the queries in the dataset in act 1202. The extracted embedding features may encode the semantic meanings of the queries.

In act 1204, one or more clusters may be generated based on the embedding features. For example, the clustering sub-system 1002 may invoke a clustering algorithm for grouping the unrecognized queries into the one or more clusters. The queries assigned to a first cluster may be deemed to be more semantically similar to one another than queries assigned to a second cluster.

In act 1206, a cluster summary is generated for one or more of the identified clusters. This may entail, for example, identifying one or more keywords that are deemed to be representative of the queries in each of the clusters. The identified keywords may be words that occur more frequently within a given cluster than in other clusters. The identified keywords may be ranked according to the number of occurrences in the queries of the cluster. In some embodiments abstractive or extractive summarization models may be used to generate words that are predicted to summarize the cluster's semantic meaning. The words may be words that do not appear in any of the queries of the cluster. The generated words may be used as the cluster summary. In some embodiments, the cluster summary may be a combination of identified keywords and the generated words.

In act 1208, an unrecognized query in one of the clusters is labeled with an intent. The labeled query may be added to a training dataset. The intent for labeling the unrecognized query may be identified and/or generated manually, automatically, or semi-automatically. For example, the chatbot administrator may manually view and select an intent from a list of available intents, and assign it to the unrecognized query via the GUI/API 114. In other examples, a template that the chatbot administrator may use to generate a new intent for the query may be recommended by, for example, the intent sub-system 1004. The template may have one or more fields that the chatbot administrator may fill, and have other fields already pre-filled based on, for example, the identified keywords for the cluster. In yet other examples, the intent-sub-system 1004 may include a generative language model for generating a new intent based on existing intents. The chatbot administrator may accept, reject, or modify the newly generated intent that is recommended for the unrecognized query.

In act 1210, the training dataset of labeled queries is used to retrain one or more machine learning models of the intent classification system 100.

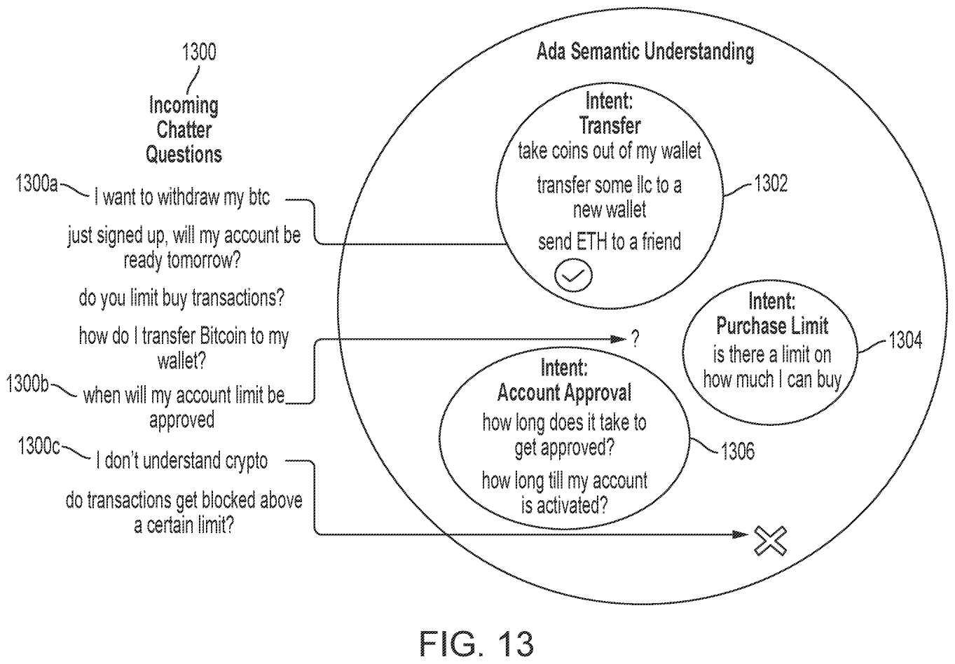

FIG. 13 is a conceptual diagram of incoming queries (chatter questions) 1300 that are provided to the intent classification system 100 for being classified into one of the known intents 1302-1306. Some queries (e.g. query 1300a) may be confidently classified (e.g. with a confidence level above a threshold) into an intent (e.g. intent 1302).

Other queries (e.g. query 1300b) may be more ambiguous. That is, the query may be classified into one of various possible intents (e.g. intents 1304, 1306), but none of the possible intents may provide a threshold level of confidence. Such queries may be identified as unrecognized, and added into the dataset of unrecognized queries.

Other queries (e.g. query 1300c) may be new questions that the intent classification system 100 has not encountered. Thus, the intent classification system 100 may not be trained to recognize such new questions. The unrecognized questions may also be added into the dataset of unrecognized queries.

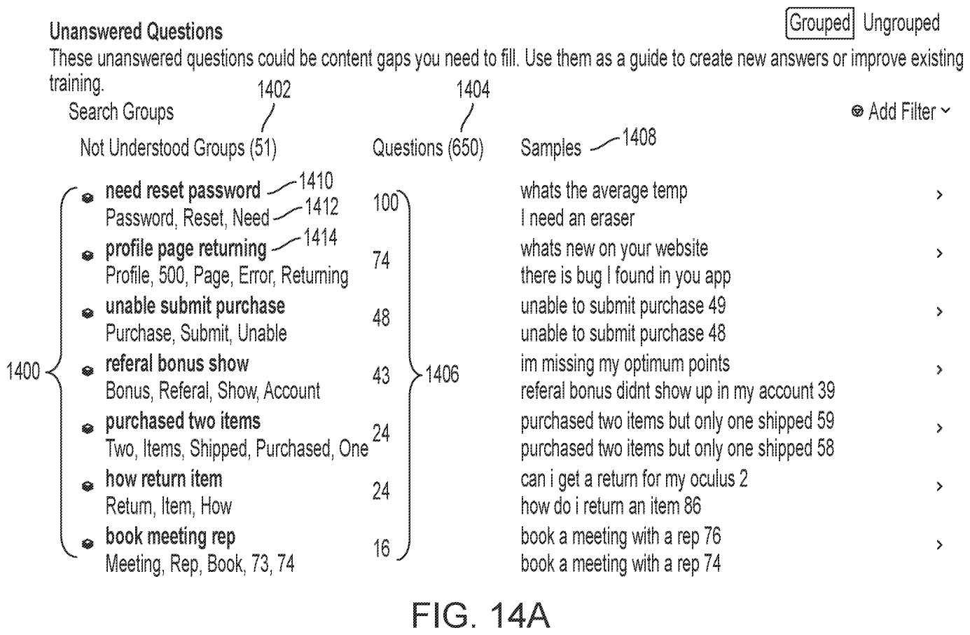

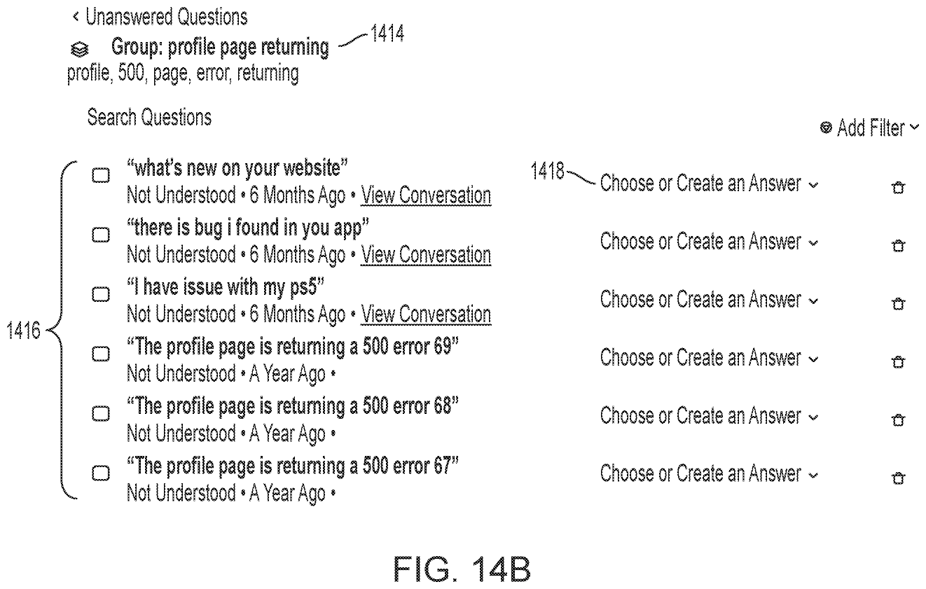

FIG. 14A is a screenshot of a display provided by the GUI 114 with information of clusters 1400 generated based on example unrecognized queries according to one embodiment. The information provided by the GUI 114 may include, for example, a number 1402 of generated clusters, a total number 1404 of unrecognized queries, and a number 1406 of unrecognized queries for each cluster. The GUI 114 may further cause display of sample unrecognized queries 1408 contained in each cluster.

In one embodiment, the queries in each cluster may be organized under topic words 1410. The topic words may be selected from the keywords 1412 associated with the cluster, and organized according to the order in which the keywords most frequently appear in the queries. For example, three of the most frequent keywords appearing in the cluster may be displayed from left to right in a decreasing order of frequency, as the topic of the cluster.

FIG. 14B is a screenshot of a display provided by the GUI 114 in response to selection of a “profile page returning” cluster 1414 according to one embodiment. Selection of the cluster 1414 may provide a list of unrecognized queries 1416 that are contained in the cluster. The GUI 114 may provide an interface 1418 that the chatbot administrator may interact with for selecting or generating an intent/answer for one or more of the queries in the list.

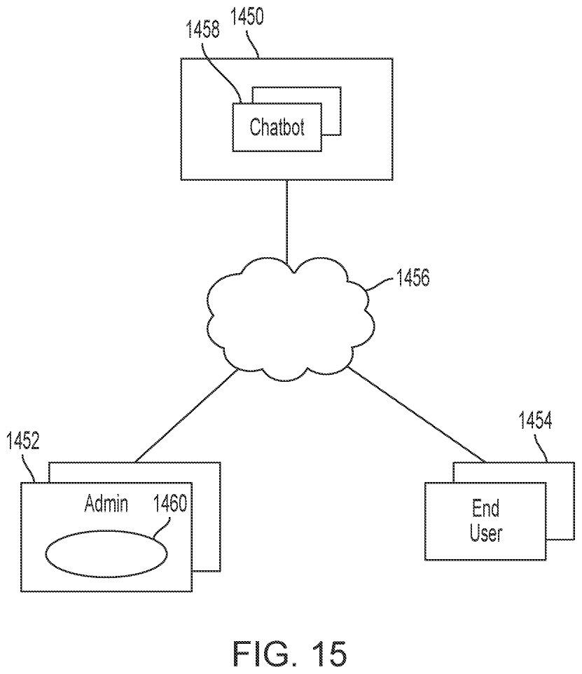

FIG. 15 is a block diagram of a network environment for employing and training chatbots according to one embodiment. The network environment includes a computing system 1450 coupled to one or more administrator devices 1452 and one or more end user devices 1454 over a data communications network 1456. The data communications network 1456 may be a local area network (LAN), private wide area network (WAN), and/or the public Internet.

The computing system 1450 may host one or more chatbot systems 1458 for handling interactions with the end user devices 1454. The chatbot system 1458 may be similar to the chatbot system 10 of FIG. 1. The chatbot system 1458 may be configured to handle interactions on behalf of a particular business or enterprise, or on behalf of multiple businesses or enterprises. For example, a separate instance of a chatbot system may be provided for each separate enterprise for handling interactions of that enterprise.

The administrator device 1452 may be a computing device accessed by a chatbot administrator for configuring and maintaining the chatbot system 1458 for a particular enterprise. For example, the chatbot administrator may use the administrator device 1452 to train the machine learning models of the chatbot system 1458 as described above.

The administrator device 1452 may be a desktop, laptop, and/or any other computing device conventional in the art. In this regard, the administrator device 1452 may include an administrator platform 1460. The administrator platform 1460 may be used by the chatbot administrator to interface with a portal (e.g. portal 112) of the chatbot system 1458 to configure, train, and maintain the chatbot system. In one embodiment, the administrator platform 1460 is downloaded as a software application on the administrator device 1452. In some embodiments, the administrator platform 1460 takes the form of a web browser, and access of the portal is over the Internet.

The end user device 1454 may also be a desktop, laptop, and/or any other computing device conventional in the art. A customer, potential customer, or other end user (collectively referenced as an end user) desiring to receive services from the contact center may initiate communications to the chatbot system 1458 using the end user device 1454. For example, the end user may formulate a query, and transmit the query to the chatbot system 1458 as a chat message, text message, social media message, and/or the like. The chatbot system 1458 may process the query and determine a user intent. Once the intent is determined, the chatbot may output an answer in response to the query.

In the various embodiments, the terms “interaction” and “communication” are used interchangeably, and generally refer to any real-time and non-real time interaction using, for example, chats, text messages, social media messages, and/or the like.

In one embodiment one or more of the systems, servers, devices, controllers, engines, and/or modules (collectively referred to as systems) in the afore-described figures are implemented via hardware or firmware (e.g. ASIC) as will be appreciated by a person of skill in the art. The one or more of the systems, servers, devices, controllers, engines, and/or modules may also be a software process or thread, running on one or more processors, in one or more computing devices.

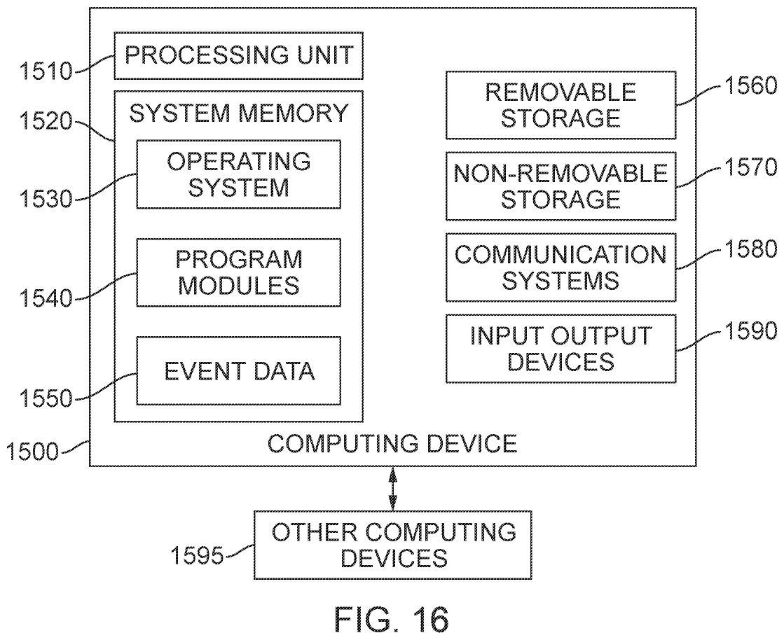

FIG. 16 is a block diagram of a computing device 1500 according to one embodiment. The computing device 1500 may include at least one processing unit (processor) 1510 and a system memory 1520. The system memory 1520 may include, but is not limited to, volatile storage (e.g., random access memory), non-volatile storage (e.g., read-only memory), flash memory, or any combination of such memories. The system memory 1520 may also include an operating system 1530 that controls the operation of the computing device 1500 and one or more program modules 1540 including computer program instructions. A number of different program modules and data files may be stored in the system memory 1520. While executing on the processing unit 1510, the program modules 1540 may perform the various processes described above.

The computing device 1500 may also have additional features or functionality. For example, the computing device 1500 may include additional data storage devices (e.g., removable and/or non-removable storage devices) such as, for example, magnetic disks, optical disks, or tape. These additional storage devices are labeled as a removable storage 1560 and a non-removable storage 1570.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In some embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

According to one embodiment, the computing device 1500 is configured to communicate with other computing devices over a network interface in a network environment. The network environment may be a virtual network environment where the various components of the network are virtualized. For example, the chatbot systems 10, 1458 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

In regards to the processes in the flow diagrams of FIGS. 11 and 12, it should be understood that the sequence of steps of the processes are not fixed, but can be modified, changed in order, performed differently, performed sequentially, concurrently, or simultaneously, or altered into any desired sequence, as recognized by a person of skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure.” Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of chatbot systems and methods for training and using the chatbot systems have been specifically described and illustrated herein, many modifications and variations will be apparent to those skilled in the art. Accordingly, it is to be understood that the chatbot systems and methods for training and using the chatbot systems constructed according to principles of this disclosure may be embodied other than as specifically described herein. The disclosure is also defined in the following claims, and equivalents thereof.

What is claimed is:

1. A method comprising:
receiving a user query;
classifying the user query via a first machine learning model;
making a first classification determination for the user query;
in response to the first classification determination, identifying features of the user query via a second machine learning model;
grouping the user query into a cluster based on the features of the user query; and
causing display of information about the cluster for prompting a user action.

2. The method of claim 1, wherein the classifying of the user query includes predicting an intent of the user query.

3. The method of claim 2, wherein the first classification determination includes a determination that prediction of the intent is below a threshold level of confidence.

4. The method of claim 1, wherein the second machine learning model includes a plurality of embedding layers, wherein the features of the user query include embeddings generated by one or more of the plurality of embedding layers.

5. The method of claim 1, wherein the second machine learning model includes a pre-trained language model, the method further comprising:
adjusting a parameter of the pre-trained language model for a particular task.

6. The method of claim 1 further comprising:
identifying a keyword from a plurality of first queries in the cluster, wherein the information about the cluster includes the keyword.

7. The method of claim 6, wherein the identifying of the keyword includes:
generating first unigrams of the first queries in the cluster;
generating second unigrams of second queries in a second cluster;
comparing the first unigrams against the second unigrams; and
selecting the keyword based on the comparing.

8. The method of claim 6 further comprising:
generating a summary of the cluster, wherein the summary includes one or more of the keywords.

9. The method of claim 1 further comprising:
generating a summary of the cluster comprising, wherein the generating of the summary includes:
invoking a summarization model based on one or more queries in the cluster;
identifying a word output by the summarization model; and
including the word into the summary.

10. The method of claim 1, wherein the user action includes identification of an intent for the user query.

11. The method of claim 8 further comprising:
labeling the user query with the intent; and
training the first machine learning model based on the user query and the intent.

12. A system comprising:
a processor; and
a memory, wherein the memory includes instructions that, when executed by the processor, cause the processor to:
receive a user query;
classify the user query via a first machine learning model;
make a first classification determination for the user query;
in response to the first classification determination, identify features of the user query via a second machine learning model;
group the user query into a cluster based on the features of the user query; and
cause display of information about the cluster for prompting a user action.

13. The system of claim 12, wherein the instructions that cause the processor to classify the user query include instructions that cause the processor to predict an intent of the user query.

14. The system of claim 13, wherein the first classification determination includes a determination that prediction of the intent is below a threshold level of confidence.

15. The system of claim 12, wherein the instructions further cause the processor to:
identify a keyword from a plurality of first queries in the cluster, wherein the information about the cluster includes the keyword.

16. The system of claim 15, wherein the instructions that cause the processor to identify the keyword include instructions that cause the processor to:
generate first unigrams of the first queries in the cluster;
generate second unigrams of second queries in a second cluster;
compare the first unigrams against the second unigrams; and
select the keyword based on the comparing.

17. The system of claim 15, wherein the instructions further cause the processor to:
generate a summary of the cluster, wherein the summary includes one or more of the keywords.

18. The system of claim 12, wherein the instructions further cause the processor to:
generate a summary of the cluster, wherein the instructions that cause the processor to generate the summary of the cluster include instructions that cause the processor to:
invoke a summarization model based on one or more queries in the cluster;
identify a word output by the summarization model; and
include the word into the summary.

19. The system of claim 12, wherein the user action includes identification of an intent for the user query.

20. The system of claim 19, wherein the instructions further cause the processor to:
label the user query with the intent; and
train the first machine learning model based on the user query and the intent.
